(19) United States
(12) Patent Application Publication
(10) Pub. No.: US 2024/0258638 A1
(43) Pub. Date: Aug. 1, 2024

(54) BATTERY UNIT AND MOVING OBJECT

(71) Applicant: HONDA MOTOR CO., LTD., Tokyo (JP)

(72) Inventor: Yuya Ishihara, Wako-shi (JP)

(21) Appl. No.: 18/423,382

(22) Filed: Jan. 26, 2024

(30) Foreign Application Priority Data
Jan. 31, 2023 (JP) 2023-013006

(51) Int. Cl. H01M 50/296; H01M 10/42; H01M 10/613; H01M 10/6568; H01M 50/209; H01M 50/51

(52) U.S. Cl. CPC H01M 50/296; H01M 10/425; H01M 10/613; H01M 10/6568; H01M 50/209; H01M 50/51; H01M 2220/20

(57) ABSTRACT

A battery unit includes: a battery module row formed of four battery modules; and a junction box. The junction box includes a first terminal connected to a first battery module which is a battery module positioned at an end of the battery module row, and a second terminal connected to a second battery module adjacent to the first battery module.

### CROSS-REFERENCE TO RELATED APPLICATIONS

This application is based upon and claims the benefit of priority from Japanese Patent Application No. 2023-013006 filed on Jan. 31, 2023, the contents of which are incorporated herein by reference.

### BACKGROUND OF THE INVENTION

### Field of the Invention

The present invention relates to a battery unit and a moving object.

### Description of the Related Art

JP 2015-032408 A discloses a battery pack.

### SUMMARY OF THE INVENTION

In the battery unit (battery pack) disclosed in JP 2015-032408 A, the overall positive terminal and the overall negative terminal of two battery modules located on the inner side among four battery modules arranged in a row are connected to a junction box. Therefore, the service plug is connected to the intermediate positive terminal and the intermediate negative terminal of two battery modules located on the outer side among the four battery modules arranged in a row. The junction box is disposed between the intermediate positive terminal and the intermediate negative terminal. That is, the junction box is disposed at the central part, and the layout of the devices is therefore restricted.

An object of the present invention is to solve the above-mentioned problem.

According to a first aspect of the present invention, there is provided a battery unit comprising: a plurality of battery modules; and an output unit configured to output electric power supplied from the battery modules, wherein the battery modules each include a plurality of battery cells that are stacked together, the plurality of battery modules are arranged in a direction intersecting a stacking direction of the battery cells, and are connected in series, a battery module row is formed of the plurality of battery modules, and a number of the battery modules included in the battery module row is four or more, and the output unit includes a first terminal connected to a first battery module which is one of the battery modules that is located at an end of the battery module row, and a second terminal connected to a second battery module of the battery modules that is adjacent to the first battery module.

According to a second aspect of the present invention, there is provided a moving object comprising the battery unit of the first aspect.

According to the present invention, the restriction of the layout of devices can be reduced.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing a connection relationship of respective members of a battery unit according to a present embodiment;

FIG. 2 is a schematic perspective view showing a battery module row and a cooling water passage;

FIG. 3 is a schematic view showing the battery unit mounted on an aircraft;

FIG. 4 is a diagram showing a connection relationship of respective members of a battery unit according to a comparative example;

FIG. 5 is an image diagram showing the arrangement of respective members in the battery unit according to the comparative example; and

FIG. 6 is an image diagram showing the arrangement of respective members in the battery unit according to the present embodiment.

### DETAILED DESCRIPTION OF THE INVENTION

### Embodiment

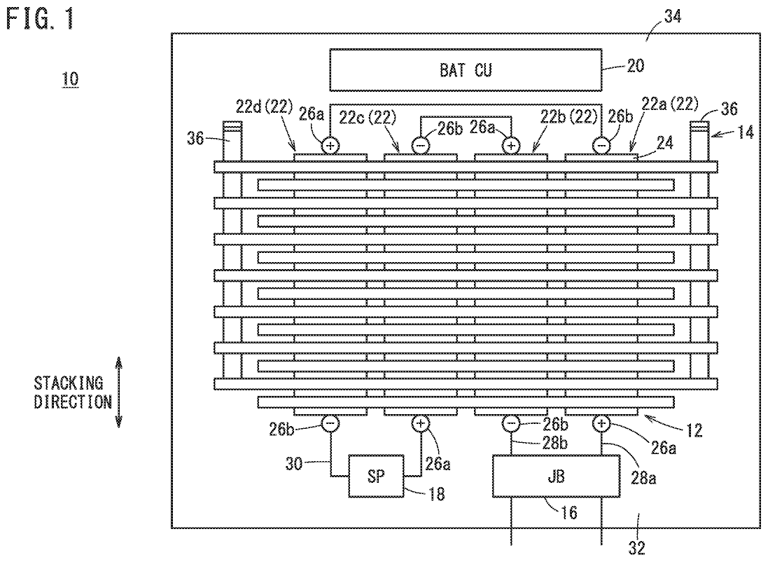

A battery unit and a moving object according to an embodiment will be described with reference to the drawings. FIG. 1 is a diagram showing a connection relationship of respective members of a battery unit 10 according to the present embodiment. The battery unit 10 is mounted on a moving object such as an airplane, a ship, or an automobile.

The battery unit 10 includes a battery module row 12, a cooling water passage 14, a junction box 16, a service plug 18, and a battery control unit 20. The junction box 16 corresponds to an output unit of the present invention. The battery control unit 20 corresponds to a low-voltage circuit of the present invention.

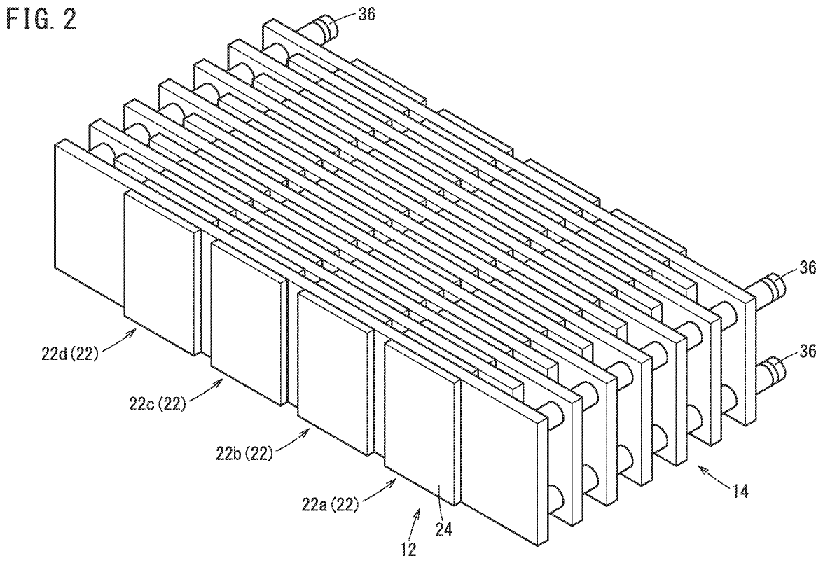

FIG. 2 is a schematic perspective view showing the battery module row 12 and the cooling water passage 14. The battery module row 12 includes four battery modules 22. The battery modules 22 are each configured by stacking a plurality of battery cells 24. The battery module 22 shown in FIG. 2 is configured by stacking seventeen battery cells 24, but the present invention is not limited thereto. For example, the battery module 22 may be configured by stacking more than seventeen battery cells 24. The cooling water passage 14 is provided between the battery cells 24 adjacent to each other. Cooling water circulates in the cooling water passage 14 to cool the battery cells 24.

The four battery modules 22 are arranged in a row in a direction intersecting the stacking direction of the battery cells 24. Hereinafter, the battery modules 22 may be referred to as a first battery module 22a, a second battery module 22b, a third battery module 22c, and a fourth battery module 22d in order from the right in FIG. 1.

The battery modules 22 each include a positive terminal 26a at one end, and a negative terminal 26b at the other end. The battery modules 22 are arranged such that the terminals having different polarities are adjacent to each other.

That is, the positive terminal 26a of the first battery module 22a and the negative terminal 26b of the second battery module 22b are adjacent to each other. The positive terminal 26a of the second battery module 22b and the negative terminal 26b of the third battery module 22c are adjacent to each other. The positive terminal 26a of the third battery module 22c and the negative terminal 26b of the fourth battery module 22d are adjacent to each other. Further, the negative terminal 26b of the first battery module 22a and the positive terminal 26a of the second battery module 22b are adjacent to each other. The negative terminal 26b of the second battery module 22b and the positive terminal 26a of the third battery module 22c are adjacent to each other. The negative terminal 26b of the third battery module 22c and the positive terminal 26a of the fourth battery module 22d are adjacent to each other.

The junction box 16 includes a first terminal 28a and a second terminal 28b. The first terminal 28a is connected to the positive terminal 26a of the first battery module 22a, and the second terminal 28b is connected to the negative terminal 26b of the second battery module 22b. Electric power output from the junction box 16 is sent to a power control unit (not shown) or the like. The power control unit includes a DC-DC converter, a DC-AC converter, an inverter, and the like. The devices mounted on the above-described moving object are driven by the electric power output from the power control unit. The junction box 16 includes a contactor or the like that interrupts the supply of electric power to the power control unit or the like.

The service plug 18 is provided on an intermediate wire 30 that connects the positive terminal 26a of the third battery module 22c and the negative terminal 26b of the fourth battery module 22d. An operator can interrupt the electrical connection between the third battery module 22c and the fourth battery module 22d by operating the service plug 18. When the electrical connection between the third battery module 22c and the fourth battery module 22d is interrupted, no electric power is supplied from the first battery module 22a and the second battery module 22b to the junction box 16. Thus, when the operator performs maintenance or the like of the device such as the junction box 16, the safety of the operator can be ensured.

The battery control unit 20 monitors the voltage between the battery cells 24 adjacent to each other. The battery control unit 20 controls the contactor or the like of the junction box 16. The battery control unit 20 is driven by a voltage lower than the voltage output from the junction box 16.

The battery module row 12 is disposed between the junction box 16 and the battery control unit 20. Further, the battery module row 12 is disposed between the service plug 18 and the battery control unit 20.

Specifically, the junction box 16 and the service plug 18 are disposed in a first side portion 32 of the battery unit 10. The first side portion 32 is located on one side of the battery module row 12 in the stacking direction of the battery cells 24. The battery control unit 20 is disposed in a second side portion 34 of the battery unit 10. The second side portion 34 is located on the other side of the battery module row 12 in the stacking direction of the battery cells 24.

Thus, the junction box 16, which outputs a relatively high voltage, can be disposed in the first side portion 32 of the battery unit 10. Further, the battery control unit 20, which is driven by a relatively low voltage, can be disposed in the second side portion 34 of the battery unit 10.

The cooling water passage 14 described above includes supply/discharge ports 36 for supplying and discharging the cooling water. The supply/discharge ports 36 are disposed in the second side portion 34 of the battery unit 10.

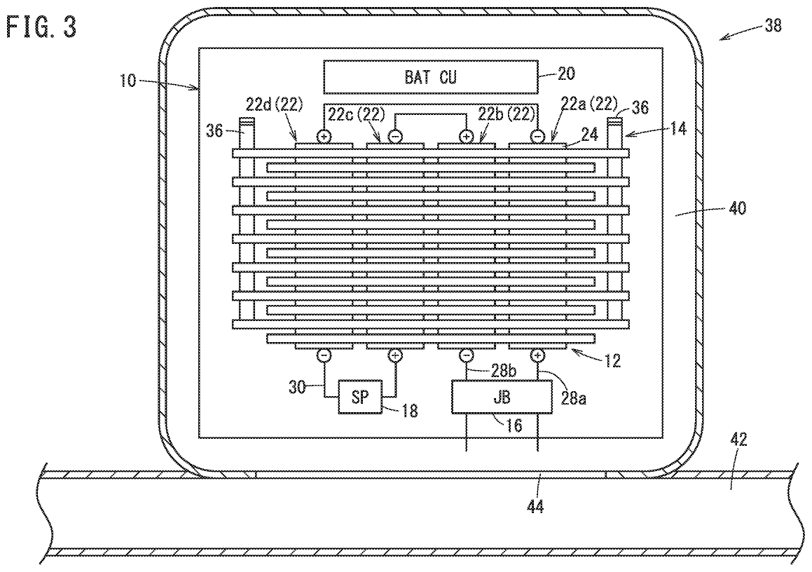

FIG. 3 is a schematic view showing the battery unit 10 in a state of being mounted on an aircraft 38. The battery unit 10 is accommodated in an accommodation room 40 provided in the aircraft 38. The accommodation room 40 is formed adjacent to an aisle 42 provided in the aircraft 38. The accommodation room 40 includes an opening 44 that opens toward the aisle 42. The opening 44 may be closed by a cover (not shown).

As shown in FIG. 3, the junction box 16 and the service plug 18 are disposed at positions facing the opening 44 in a state where the battery unit 10 is accommodated in the accommodation room 40. Therefore, when the operator operates the service plug 18 or when the operator performs maintenance or the like of the junction box 16, the operator can easily perform the work.

### Advantageous Effects

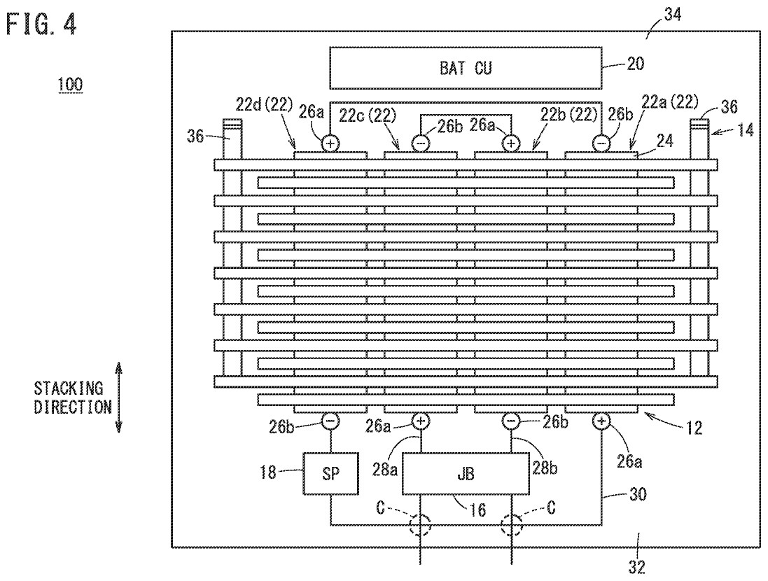

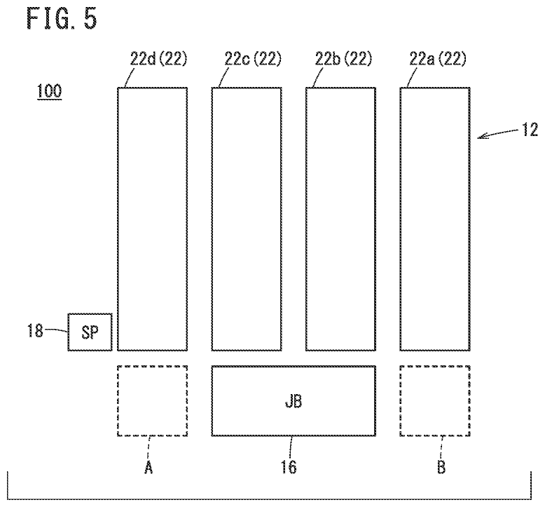

FIG. 4 is a diagram showing a connection relationship of respective members of a battery unit 100 according to a comparative example. FIG. 5 is an image diagram showing the arrangement of respective members in the battery unit 100 according to the comparative example. FIG. 5 shows the arrangement of the battery module row 12, the junction box 16, and the service plug 18.

As shown in FIG. 4, in the battery unit 100 of the comparative example, the first terminal 28a of the junction box 16 is connected to the positive terminal 26a of the third battery module 22c. Further, the second terminal 28b of the junction box 16 is connected to the negative terminal 26b of the second battery module 22b. The second battery module 22b and the third battery module 22c are both positioned on the inner side of the battery module row 12.

In addition, in the battery unit 100 of the comparative example, the service plug 18 is provided on the intermediate wire 30 that connects the positive terminal 26a of the first battery module 22a and the negative terminal 26b of the fourth battery module 22d. The first battery module 22a and the fourth battery module 22d are both positioned at the ends of the battery module row 12.

As shown in FIG. 5, in the battery unit 100 of the comparative example, the junction box 16 is disposed at the central part of the battery module row 12. As a result, the areas of a space A and a space B that are adjacent to the junction box 16 cannot be secured. Therefore, only relatively small members can be disposed in the space A and the space B, and the layout of the battery unit 100 is restricted.

In addition, in the battery unit 100 of the comparative example, the first terminal 28a and the second terminal 28b of the junction box 16 intersect with the intermediate wire 30 at locations indicated by circles C in FIG. 4. Therefore, short circuit may occur between the first terminal 28a and the intermediate wire 30. Further, short circuit may occur between the second terminal 28b and the intermediate wire 30.

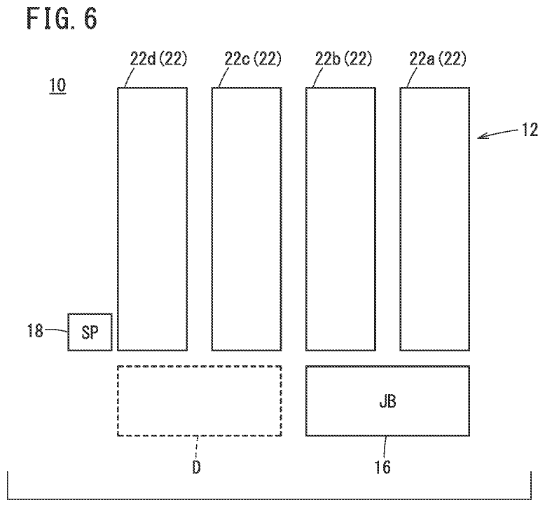

FIG. 6 is an image diagram showing the arrangement of the respective members in the battery unit 10 of the present embodiment. FIG. 6 shows the arrangement of the battery module row 12, the junction box 16, and the service plug 18.

As shown in FIG. 1, in the battery unit 10 of the present embodiment, the first terminal 28a of the junction box 16 is connected to the positive terminal 26a of the first battery module 22a. Further, the second terminal 28b of the junction box 16 is connected to the negative terminal 26b of the second battery module 22b. The first battery module 22a is positioned at an end of the battery module row 12, and the second battery module 22b is adjacent to the first battery module 22a.

In addition, in the battery unit 10 of the present embodiment, the service plug 18 is provided on the intermediate wire 30 that connects the positive terminal 26a of the third battery module 22c and the negative terminal 26b of the fourth battery module 22d. The fourth battery module 22d is positioned at an end of the battery module row 12, and the third battery module 22c is adjacent to the fourth battery module 22d.

Therefore, as shown in FIG. 6, in the battery unit 10 of the present embodiment, the junction box 16 is disposed at a position offset from the central part of the battery module row 12. As a result, the area of a space D adjacent to the junction box 16 can be increased as compared with the areas of the space A and the space B of the battery unit 100 of the comparative example. Thus, a relatively large member can be disposed in the space D, and the restriction of the layout of the battery unit 10 can be reduced.

In addition, in the battery unit 10 of the present embodiment, as shown in FIG. 1, the first terminal 28a and the second terminal 28b of the junction box 16 do not intersect with the intermediate wire 30. Therefore, short circuit between the first terminal 28a and the intermediate wire 30 or short circuit between the second terminal 28b and the intermediate wire 30 can be prevented.

In the battery unit 10 of the present embodiment, the junction box 16 and the service plug 18 are disposed in the first side portion 32 of the battery unit 10, and the battery control unit 20 is disposed in the second side portion 34 of the battery unit 10.

As a result, the junction box 16, which outputs a relatively high voltage, and the battery control unit 20, which is driven by a relatively low voltage, can be disposed apart from each other.

In the battery unit 10 of the present embodiment, the supply/discharge ports 36 of the cooling water passage 14 are disposed in the second side portion 34 of the battery unit 10. The battery control unit 20 driven by a relatively low voltage is disposed in the second side portion 34, and the junction box 16 is disposed in the first side portion 32. As described above, the first side portion 32 is located on the opposite side from the second side portion 34. As a result, even if the cooling water leaks from the supply/discharge ports 36, the battery unit 10 can be prevented from being damaged.

### Inventions Obtained from Embodiment

The inventions that can be grasped from the above embodiment will be described below.

The battery unit (10) includes: the plurality of battery modules (22); and the output unit (16) configured to output electric power supplied from the battery modules, wherein the battery modules each include the plurality of battery cells (24) that are stacked together, the plurality of battery modules are arranged in a direction intersecting the stacking direction of the battery cells, and are connected in series, the battery module row (12) is formed of the plurality of battery modules, and the number of the battery modules included in the battery module row is four or more, and the output unit includes the first terminal (28a) connected to the first battery module (22a) which is one of the battery modules that is located at an end of the battery module row, and the second terminal (28b) connected to the second battery module (22b) of the battery modules that is adjacent to the first battery module. According to this feature, the restriction of the layout of the battery unit can be reduced.

In the above-described battery unit, the positive terminal (26a) is provided at one end of each of the battery modules, and the negative terminal (26b) is provided at another end of each of the battery modules. According to this feature, the restriction of the layout of the battery unit can be reduced.

In the above-described battery unit, the positive terminal of the first battery module and the negative terminal of the second battery module may be adjacent to each other.

The above-described battery unit may further include the service plug (18) configured to interrupt electrical connection between the third battery module (22c) of the plurality of battery modules and the fourth battery module (22d) of the plurality of battery modules. According to this feature, the safety of the operator can be ensured.

The above-described battery unit may further include the low-voltage circuit (20) configured to be driven by a voltage lower than the voltage output from the output unit, and the battery module row may be positioned between the output unit and the low-voltage circuit. According to this feature, the output unit and the low-voltage circuit can be disposed apart from each other.

The above-described battery unit may further include the cooling water passage (14) configured to cool the battery modules, the output unit may be disposed in the first side portion (32) located on one side of the battery module row in the stacking direction of the battery cells, the low-voltage circuit may be disposed in the second side portion (34) located on another side of the battery module row in the stacking direction of the battery cells, and the supply/discharge port (36) provided in the cooling water passage may be disposed in the second side portion. According to this feature, it is possible to prevent the battery unit from being damaged.

The moving object (38) includes the above-described battery unit. According to this feature, the restriction of the layout of the battery unit can be reduced.

The present invention is not limited to the above disclosure, and various modifications are possible without departing from the essence and gist of the present invention.

1. A battery unit comprising:
a plurality of battery modules; and
an output unit configured to output electric power supplied from the battery modules,
wherein the battery modules each include a plurality of battery cells that are stacked together,
the plurality of battery modules are arranged in a direction intersecting a stacking direction of the battery cells, and are connected in series,
a battery module row is formed of the plurality of battery modules, and a number of the battery modules included in the battery module row is four or more, and
the output unit includes a first terminal connected to a first battery module which is one of the battery modules that is located at an end of the battery module row, and a second terminal connected to a second battery module of the battery modules that is adjacent to the first battery module.

2. The battery unit according to claim 1, wherein
a positive terminal is provided at one end of each of the battery modules, and a negative terminal is provided at another end of each of the battery modules.

3. The battery unit according to claim 2, wherein
the positive terminal of the first battery module and the negative terminal of the second battery module are adjacent to each other.

4. The battery unit according to claim 1, further comprising a service plug configured to interrupt electrical connection between a third battery module of the plurality of battery modules and a fourth battery module of the plurality of battery modules.

5. The battery unit according to claim 1, further comprising a low-voltage circuit configured to be driven by a voltage lower than a voltage output from the output unit, wherein
the battery module row is positioned between the output unit and the low-voltage circuit.

6. The battery unit according to claim 5, further comprising a cooling water passage configured to cool the battery modules, wherein
the output unit is disposed in a first side portion located on one side of the battery module row in the stacking direction of the battery cells,
the low-voltage circuit is disposed in a second side portion located on another side of the battery module row in the stacking direction of the battery cells, and
a supply/discharge port provided in the cooling water passage is disposed in the second side portion.

7. A moving object comprising the battery unit according to claim 1.
